(19) United States
(12) Patent Application Publication
(10) Pub. No.: US 2026/0060308 A1
(43) Pub. Date: Mar. 5, 2026

(54) AEROSOL-GENERATING DEVICE, HEATING ASSEMBLY, AND HEATING STRUCTURE

(71) Applicant: SMOORE INTERNATIONAL HOLDINGS LIMITED, George Town (KY)

(72) Inventors: Guo ZHANG, Shenzhen (CN); Lei MA, Shenzhen (CN); Xingfu ZHANG, Shenzhen (CN); Riming FANG, Shenzhen (CN); Hongming ZHOU, Shenzhen (CN); Rihong LI, Shenzhen (CN); Qingchen CHU, Shenzhen (CN)

(21) Appl. No.: 19/383,626

(22) Filed: Nov. 8, 2025

Related U.S. Application Data
(63) Continuation of application No. PCT/CN2024/091488, filed on May 7, 2024.

(30) Foreign Application Priority Data
May 9, 2023 (CN) 202310520659.9

(51) Int. Cl. A24F 40/46; A24F 40/20

(52) U.S. Cl. CPC A24F 40/46; A24F 40/20

(57) ABSTRACT

A heating structure includes: a heating component; a tube body; and a mounting member. The tube body is provided with a tube opening. The mounting member is assembled with an end of the tube body provided with the tube opening. The heating component includes a heating portion and a conductive portion. The heating portion is arranged in the tube body and is at least partially spaced apart from a tube wall of the tube body so as to radiate infrared light through the tube body to heat an aerosol-generating substrate. The conductive portion penetrates through the mounting member and is connected to the heating portion so as to fix the heating component to the mounting member.

### CROSS-REFERENCE TO PRIOR APPLICATION

This application is a continuation of International Patent Application No. PCT/CN2024/091488, filed on May 7, 2024, which claims priority to Chinese Patent Application No. 202310520659.9, filed on May 9, 2023. The entire disclosure of both applications is hereby incorporated by reference herein.

### FIELD

The present disclosure relates to the field of atomization, and in particular to an aerosol-generating device, a heating assembly, and a heating structure.

### BACKGROUND

In the atomization field of heating without combustion, a central heating structure, a peripheral heating structure, or the like is usually used to heat an aerosol-generating substrate. A heating structure in the related technology may usually include a housing and a heating component. The heating component is generally mounted in the housing directly. After the heating component is powered on, a radiated light wave may be generated and penetrates through the housing to heat the aerosol-generating substrate. The housing has the functions of isolating a heating element and allow the radiated light wave to penetrate through. In the prior art, the assembly of the heating component in the housing is very difficult, and the unstable assembly of the heating component is easily caused, affecting the temperature field distribution of the entire heating element, and resulting in inconsistent draw sensation. How to stably assemble the heating element in the housing is a problem that needs to be solved currently.

### SUMMARY

In an embodiment, the present invention provides a heating structure, comprising: a heating component; a tube body; and a mounting member, wherein the tube body is provided with a tube opening, wherein the mounting member is assembled with an end of the tube body provided with the tube opening, wherein the heating component comprises a heating portion and a conductive portion, wherein the heating portion is arranged in the tube body and is at least partially spaced apart from a tube wall of the tube body so as to radiate infrared light through the tube body to heat an aerosol-generating substrate, and wherein the conductive portion penetrates through the mounting member and is connected to the heating portion so as to fix the heating component to the mounting member.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an aerosol-generating device and an aerosol-generating substrate assembled in a first embodiment of the present disclosure;

FIG. 2 is a cross-sectional view of the aerosol-generating device shown in FIG. 1;

FIG. 3 is a schematic structural diagram of a heating assembly in the aerosol-generating device shown in FIG. 2;

FIG. 4 is a cross-sectional view of the heating assembly shown in FIG. 3;

FIG. 5 is a schematic exploded structural view of the heating assembly shown in FIG. 4;

FIG. 6 is a schematic structural diagram of a heating structure in the heating assembly shown in FIG. 5;

FIG. 7 is a cross-sectional view of the heating structure shown in FIG. 6;

FIG. 8 is a schematic exploded structural view of the heating structure shown in FIG. 7;

FIG. 9 is a schematic structural diagram of a heating component of a heating structure in an aerosol-generating device in a second embodiment of the present disclosure;

FIG. 10 is a schematic structural diagram of a heating component of a heating structure in an aerosol-generating device in a third embodiment of the present disclosure;

FIG. 11 is a schematic structural diagram of a heating component of a heating structure in an aerosol-generating device in a fourth embodiment of the present disclosure; and

FIG. 12 is a schematic structural diagram of a heating component of a heating structure in an aerosol-generating device in a fifth embodiment of the present disclosure.

### DETAILED DESCRIPTION

In an embodiment, the present invention provides an improved aerosol-generating device, a heating assembly, and a heating structure.

In an embodiment, the present invention provides a heating structure, including a heating component, a tube body, and a mounting member.

The tube body is provided with a tube opening.

The mounting member is assembled with the end of the tube body provided with the tube opening.

The heating component includes a heating portion and a conductive portion. The heating portion is arranged in the tube body and is at least partially spaced apart from the tube wall of the tube body to radiate infrared light, and the infrared light passes through the tube body to heat an aerosol-generating substrate. The conductive portion penetrates through the mounting member and is connected to the heating portion, so as to fix the heating component to the mounting member.

In some embodiments, the mounting member is provided with a channel for the conductive portion to penetrate through; and the heating component is partially fixed to the end surface of the channel arranged towards the heating portion, and/or the heating component is partially fixed to at least part of the inner wall of the channel.

In some embodiments, the heating component includes a first direction and a second direction perpendicular to the first direction, the second direction being a penetrating direction in which the conductive portion penetrates through the channel; and
the size of the end of the conductive portion close to the heating portion in the first direction is greater than or equal to the size of the channel in the first direction, or the size of the end of the heating portion close to the conductive portion in the first direction is greater than or equal to the size of the channel in the first direction.

In some embodiments, the mounting member is provided with a channel for the conductive portion to penetrate through, and has a first end located at or close to the tube opening and a second end arranged opposite to the first end;
each channel extends from the second end to the first end; and
the end of the conductive portion close to the heating portion is provided with a connection portion connected to the heating portion; and the connection portion is fixed to the second end.

In some embodiments, the cross-sectional area of the connection portion is greater than or equal to the cross-sectional area of the channel.

In some embodiments, the cross-sectional area of the connection portion is 0.07 mm²-0.8 mm², and the cross-sectional area of the channel is 0.03 mm²-0.28 mm².

In some embodiments, the width of the cross section of the connection portion is 0.2 mm-1.5 mm, and the width of the cross section of the channel is 0.2 mm-0.6 mm.

In some embodiments, the mounting member is provided with a through hole or a through groove; and the channel is formed in the through hole or the through groove.

In some embodiments, two conductive portions are provided, and the two conductive portions are insulated or spaced apart.

In some embodiments, the mounting member is an insulating member, or the surface where the mounting member is in contact with the conductive portion is provided with an insulating structure; and
the two conductive portions are insulated through the mounting member.

In some embodiments, the mounting member is at least partially inserted in the tube body, and is in interference fit with the tube body.

In some embodiments, the tube body includes a pointed top, and the end of the heating portion away from the conductive portion is in interference fit or contact with the part of the inner wall of the pointed top.

In some embodiments, the end of the heating portion close to the pointed top has the maximum radial size or width size of the heating portion.

In some embodiments, the heating portion includes a spiral section, and the radial size or width size of the end of the heating portion close to the pointed top is less than or equal to the maximum radial size of the spiral section.

In some embodiments, the heating portion includes a spiral section close to the pointed top, the end of the spiral section close to the pointed top includes a bent portion or an annular portion, the spacing between the bent portion or the annular portion and the adjacent spiral section is greater than the pitch of the spiral section, and the spiral section away from the bent portion or the annular portion is spaced apart from the inner wall of the tube body.

In some embodiments, the heating portion includes a spiral section close to the pointed top, the end of the spiral section close to the pointed top includes a tip or a flat portion, the width of the tip or the flat portion is less than the outer diameter of the spiral section, the tip or the flat portion abuts against the inner wall of the pointed top, and the spiral section away from the tip or the flat portion is spaced apart from the inner wall of the tube body.

In some embodiments, the heating portion includes a spiral section close to the pointed top, the end of the spiral section close to the pointed top includes a top, the axial direction of the top has a set height, and the resistance value of the spiral section adjacent to the top and having the same height is greater than the resistance value of the top.

In some embodiments, the part of the conductive portion arranged close to the first end is bent and passes through one side of the mounting member.

In some embodiments, the outer wall of the tube body is provided with a positioning portion for mounting and positioning a heating structure.

In some embodiments, a limiting portion is arranged between the heating portion and the mounting member and is configured to limit the distance between the heating portion and the mounting member.

The present disclosure further constructs a heating assembly, including a holder and the heating structure of the present disclosure arranged on the holder.

In some embodiments, the holder is provided with a mounting hole for the part of the heating structure to penetrate through; and
a seal structure is arranged between the outer wall of the heating structure and the inner wall of the mounting hole.

In some embodiments, a limiting structure for limiting and mounting the heating structure is arranged in the holder.

The present disclosure further constructs an aerosol-generating device, including the heating structure of the present disclosure and a power supply assembly conductively connected to the heating structure.

The implementation of the aerosol-generating device, and the heating assembly and the heating structure in the present disclosure has the following beneficial effects: according to the heating structure, the conductive portion on the heating component penetrates through the mounting member and is connected to the heating portion to fix the heating component on the mounting member, thereby facilitating the mounting and positioning of the heating component, so as to enable the heating component to be stably fixed in the tube body to improve the assembling convenience of the heating structure and the stability of the heating structure.

Description of Reference Numerals: 100, aerosol-generating device; 200, aerosol-generating substrate; 10, heating assembly; 20, power supply assembly; 30, casing; 40, extractor; 11, heating structure; 111, tube body; 111a, cylindrical body; 111b, pointed top; 1110, cavity; 1111, tube opening; 112, heating component; 1120, heating element; 1121, heating portion; 1122, conductive portion; 1123, connection portion; 1124, spiral section; 1125, annular portion; 1126, bent portion; 113, mounting member; 113a, first end; 113b, second end; 1131, channel; 114, positioning portion; 12, holder; 121, holder body; 1210, accommodating cavity; 122, support wall; 123, mounting hole; 13, base; 131, bottom wall; 132, limiting structure; 1321, limiting boss; and 14. seal structure.

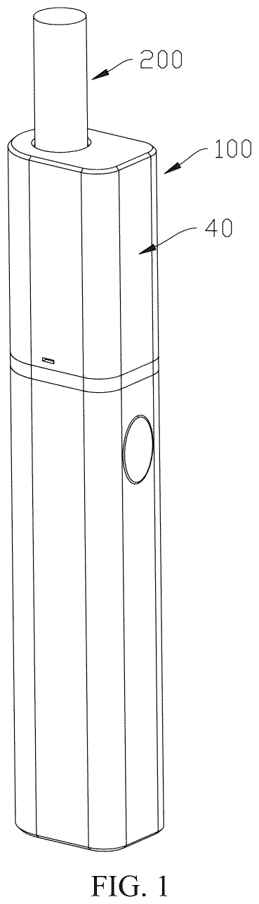

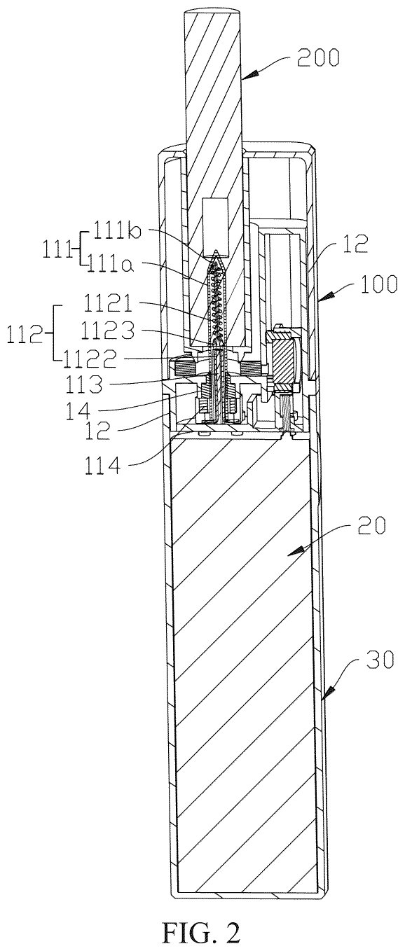

FIG. 1 and FIG. 2 show a first embodiment of an aerosol-generating device of the present disclosure. The aerosol-generating device 100 may heat an aerosol-generating substrate 200 in a heating without combustion manner, and has good atomization stability and good atomization taste. In this embodiment, the aerosol-generating substrate 200 may be arranged on the aerosol-generating device 100 in a pluggable manner. The aerosol-generating substrate 200 may be cylindrical. Specifically, the aerosol-generating substrate may be a filament-shaped, sheet-shaped or integrally formed solid material made of leaves and/or stalks of plants, and an aroma component may be further added to the solid material.

As shown in FIG. 1 and FIG. 2, in this embodiment, the aerosol-generating device 100 includes a heating assembly 10, a power supply assembly 20, and a casing 30. The heating assembly 10 may be partially inserted into the aerosol-generating substrate 200. Specifically, the heating assembly may be partially inserted into a substrate section of the aerosol-generating substrate 200, and radiates infrared light in a powered-on state to heat the substrate section of the aerosol-generating substrate 200 for atomization to form an aerosol. The heating assembly 10 has the advantages of easiness in assembling, simple structure, high atomization efficiency, strong consistency and stability, and long service life. The power supply assembly 20 is configured to supply power to the heating assembly 10. The casing 30 may accommodate the power supply assembly 20 and may be assembled with the heating assembly 10. In this embodiment, the aerosol-generating device 100 includes an extractor 40, and the extractor 40 may be assembled with the heating assembly 10, and is configured to accommodate the aerosol-generating substrate 200.

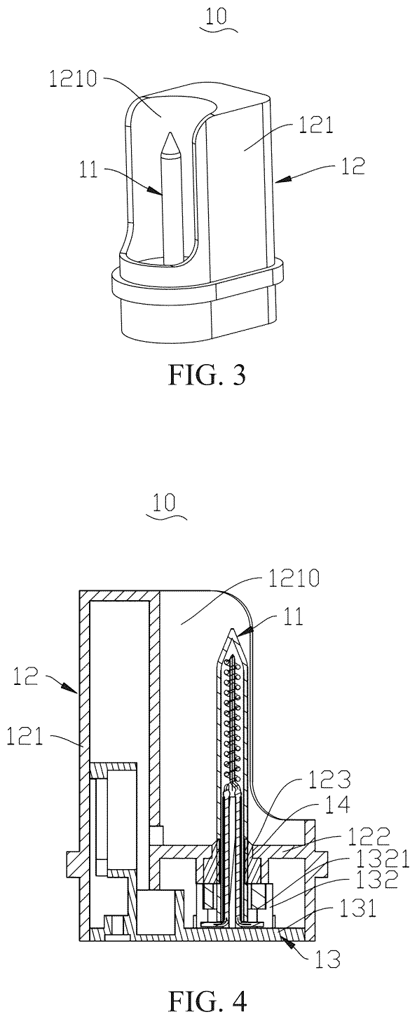

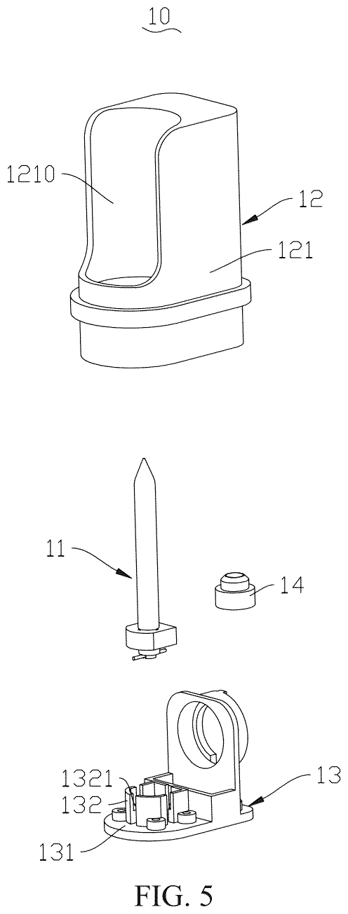

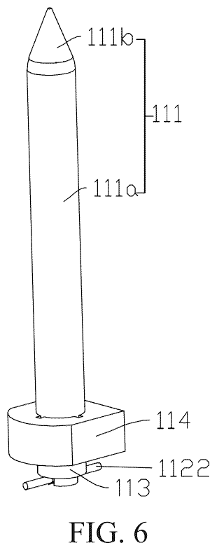

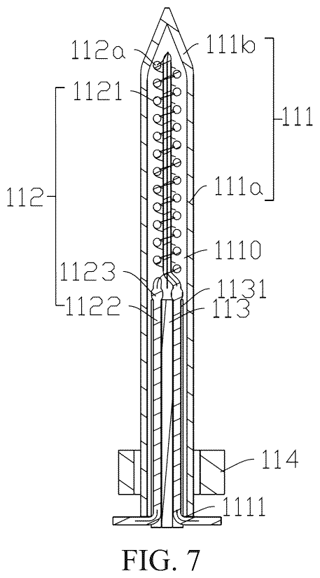

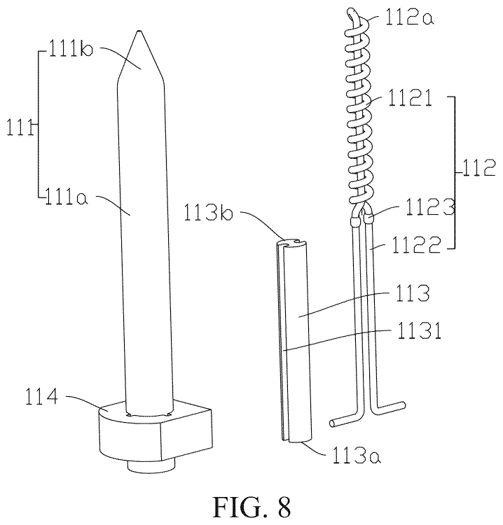

As shown in FIG. 3 to FIG. 8, further, in this embodiment, the heating assembly 10 includes a heating structure 11 and a holder 12. The heating structure 11 is arranged on the holder 12, may be at least partially inserted into the aerosol-generating substrate 200, and heats the aerosol-generating substrate 200 by radiating infrared light. The heating structure 11 may be inserted along the axial direction of the aerosol-generating substrate 200, and may be located at the central axis of the aerosol-generating substrate 200. It can be understood that in some other embodiments, the heating structure 11 may also sleeve the outer circumference of the aerosol-generating substrate 200 and radiate infrared light towards the aerosol-generating substrate 200. The holder 12 is configured to mount and fix the overall heating structure 11 to play a role in supporting the heating structure 11. In this embodiment, the holder 12 may be omitted.

In this embodiment, the heating structure 11 includes a tube body 111 and a heating component 112. In this embodiment, the tube body 111 covers at least part of the heating component 112 and may allow light waves to penetrate into the aerosol-generating substrate 200. Specifically, in this embodiment, the tube body 111 may allow the infrared light to penetrate through, so that the heating component 112 may radiate the infrared light to heat the aerosol-generating substrate 200. In this embodiment, the heating component 112 is partially arranged in the tube body 111, and is configured to radiate infrared light, and the infrared light passes through the tube body 111 and enters the aerosol-generating substrate 200. In a powered-on state, the heating component 112 may be rapidly heated to about 1000° C. after 1 s-3 s, the surface temperature of the tube body 111 may be controlled at about 350° C., and the atomization temperature of the aerosol-generating substrate 200 may be controlled at 300° C.-350° C., thereby achieving accurate atomization of the aerosol-generating substrate 200 at 2 μm-4.75 μm and 8 μm-11 μm wavelength bands. The maximum operating temperature of the heating component 112 of the present disclosure ranges from 500° C. to 1300° C., which is much higher than the maximum operating temperature of a heating element in the prior art. In this implementation, the tube body is a tube body with a circular cross-section at any position. It should be noted that the above temperature increasing speed may be adjusted according to habits or other requirements of users. For example, the temperature is increased to about 1000° C. after 1 s-3 s, which can meet the requirement of inserting and smoking the cigarette immediately, and there is no need to wait for about 15 s for preheating like the prior art. In addition, in some embodiments, in a preheating process, the surface temperature of the tube body 111 may reach 550° C., which may be a local maximum temperature of the tube body 111, and has a relatively short duration. Because of a relatively small heat capacity, the temperature may be reduced relatively rapidly, and the aerosol-generating substrate cannot be over-roasted.

In this embodiment, the tube body 111 may be a quartz glass tube. Of course, it can be understood that in some other embodiments, the tube body 111 is not limited to an infrared transmitting quartz tube, or may be other window materials that may allow light waves to penetrate through, such as transparent ceramics and diamond.

In this embodiment, the tube body 111 has a hollow structure. Specifically, in this embodiment, the cross section of the tube body 111 may be approximately circular. Of course, it can be understood that in some other embodiments, the cross section of the tube body 111 is not limited to a circular shape, for example, may be of an elliptical shape, a square shape, or a triangular prism shape. In this embodiment, the tube body 111 includes a cylindrical body 111a and a pointed top 111b, and the cylindrical body 111a may be cylindrical and arranged hollowly. It can be understood that in some other embodiments, the cylindrical body 111a is not limited to a cylindrical shape, and may be of a cuboid shape or other shapes. The pointed top 111b is arranged at one end of the cylindrical body 111a. By arranging the pointed top 111b, at least part of the heating structure 11 may be inserted in and removed from the aerosol-generating substrate 200. The pointed top 111b may be a cone. In this embodiment, a cavity 1110 is formed on the inner side of the tube body 111. The cavity 1110 is a cylindrical cavity and may be unsealed. When the heating component 112 is mounted therein, the cavity 1110 does not need to be vacuumized or filled with an inert gas. In this embodiment, the tube body 111 has a tube opening 1111, and the tube opening 1111 is arranged at the end of the cylindrical body 111a away from the pointed top 111b and is communicated with the cavity 1110 to mount the heating component 112 into the cavity 1110.

In this embodiment, the heating component 112 may include a heating portion 1121, two conductive portions 1122, and two connection portions 1123. In this embodiment, the heating portion 1121 is arranged in the tube body 111, and is at least partially spaced apart from the tube wall of the tube body 111, and may radiate infrared light in a powered-on state, and the infrared light may pass through the tube body 111 to penetrate into the aerosol-generating substrate 200. Specifically, in this embodiment, the heating portion 1121 may not be in contact with the tube wall of the cylindrical body 111a as a whole, that is, the heating portion is spaced apart from the tube wall of the cylindrical body 111a as a whole. Each conductive portion 1122 is connected to a connection portion 1123, and is connected to the heating portion 1121 through the connection portion 1123. The two conductive portions 1122 are spaced apart, and are independent of each other or insulated from each other. Both the conductive portions 1122 may be led out from the tube body 111 and are conductively connected to the power supply assembly 20. Each connection portion 1123 is arranged corresponding to one conductive portion 1122, the conductive portion 1122 is arranged at the end of the conductive portion 1122 close to the heating portion 1121, and the connection portion is configured to connect the conductive portion 1122 to the heating portion 1121.

In this embodiment, the heating portion 1121 may be approximately cylindrical. Specifically, the heating portion may be helically cylindrical. It can be understood that in some other embodiments, the heating portion 1121 is not limited to a helically cylindrical shape. In some other embodiments, the heating portion 1121 may be of a longitudinal sheet shape, or may also be of an M-shaped structure, an N-shaped structure, or structures in other shapes. The heating portion 1121 may be formed by at least one longitudinal heating element 1120 by way of winding. Specifically, in this embodiment, the heating element 1120 may be one piece, and the heating element 1120 may be bent to form two ends and then wound in a single-spiral or double-spiral winding manner. In this embodiment, a plurality of heating elements 1120 may also be provided. One ends of the plurality of heating elements 1120 may be connected and wound to form a heating portion 1121 with a single-spiral structure, a double-spiral structure, an M-shaped structure, or an N-shaped structure. The heating element herein may be a metal wire.

In this embodiment, the end of the heating portion 1121 away from the conductive portion 1122 is in interference fit or overlapped with a part of the inner wall of the pointed top 111b. That is, the end of the heating portion 1121 away from the conductive portion 1122 and the pointed top 111b may have a limiting function, so that the heating portion 1121 is fixed in the tube body 111 and is spaced apart from the tube wall of the cylindrical body 111a.

In this embodiment, the heating element 1120 may be longitudinally arranged, and the cross section of the heating element may be approximately circular. Of course, it can be understood that in some other embodiments, the cross section of the heating element 1120 is not limited to a circular shape, and may be of a square shape or other shapes. In this embodiment, the heating element 1120 may include a heating substrate and a thermal radiation layer arranged on the heating substrate. The heating substrate may generate heat in a powered-on state. The heating substrate may be a conventional heating wire or heating sheet. Specifically, the heating substrate may be a metal wire, and may be selected from nickel-chromium alloy, iron-chromium-aluminum alloy [symbol] such as an iron-chromium-aluminum alloy wire), or other metal materials with good high-temperature oxidation resistance, high stability, and good deformation resistance. The thermal radiation layer may be an infrared layer. The infrared layer may be formed by forming an infrared layer forming substrate on the heating substrate by way of high-temperature heat treatment, and may radiate infrared light, where the infrared layer forming substrate may be a silicon carbide substrate, a spinel substrate, or a composite substrate thereof. It can be understood that in some other embodiments, the thermal radiation layer is not limited to the infrared layer. In some other embodiments, the thermal radiation layer may be a composite infrared layer. In this embodiment, the heating element 1120 may further include an antioxidant layer formed between the heating substrate and the thermal radiation layer. In this embodiment, the heating substrate is subjected to high-temperature heat treatment and forms a dense oxide film on its own surface, and the oxide film forms the antioxidant layer.

In this embodiment, the two conductive portions 1122 are arranged at one end of the heating portion 1121, and each conductive portion 1122 may be connected to one end of the heating element 1120. The two conductive portions 1122 are arranged in an insulated manner. Each conductive portion 1122 may be led out from the tube opening 1111, and a section of each conductive portion 1122 led out from the tube opening 111 may be bent. In this embodiment, the conductive portion 1122 may be longitudinally arranged, and the conductive portion 1122 may be a lead wire. Of course, it can be understood that in some other embodiments, the conductive portion 1122 is not limited to the lead wire, and may be a conductive sheet, a conductive thimble, or other conductive structures. In this embodiment, the conductive portion 1122 and the heating portion 1121 may be welded to form an integrated structure. It can be understood that in some other embodiments, the conductive portion 1122 is not limited to be connected to the heating portion 1121 by welding, but may also be connected to the heating portion by plugging or other ways. The conductive portion 1122 and the heating portion 1121 are fixedly arranged, and the two conductive portions 1122 are led out from the same end of the heating portion 1121, thereby facilitating the mounting of the heating component 112. In this embodiment, the power supply assembly 20 includes two electrodes, and each conductive portion 1122 may be conductively connected to one electrode. In this embodiment, the conductive portion 1122 may be directly welded to the electrode. In some other embodiments, the conductive portion 1122 may also be in contact with and in conduction with the electrode. For example, one end of the conductive portion 1122 may be connected to or form a first contact, and the electrode is provided with a second contact. When the heating assembly 10 and the power supply assembly 20 are assembled, the first contact and the second contact may be in contact and in conduction. The heating assembly 10 and the power supply assembly 20 may be disassembled and assembled by contact connection.

In this embodiment, the connection portion 1123 may form an integrated structure with the conductive portion 1122 and the heating portion 1121. Specifically, in this embodiment, the connection portion 1123 may be a welding point. In some other embodiments, the connection portion 1123 is not limited to the welding point, and may be a connection sleeve or other connection structures. In this embodiment, the cross-sectional area of the connection portion 1123 may be greater than the cross-sectional area of the conductive portion 1122, thereby facilitating positioning and mounting of the heating component 112. Specifically, the cross section of the connection portion 1123 may be approximately circular. It can be understood that in some other embodiments, the cross section of the connection portion 1123 is not limited to a circular shape, and may be of a square shape, an elliptical shape, or other shapes. In this embodiment, the cross-sectional area of the connection portion 1123 is 0.07 mm²-0.8 mm². In this embodiment, the width of the cross section of the connection portion 1123 may be 0.2 mm-1.5 mm. Further, the cross section of the connection portion 1123 may be circular, and the diameter of the cross section of the connection portion is 0.2 mm-1.5 mm.

In some other embodiments, the connection portion 1123 may be omitted. The cross-sectional size of the end of the conductive portion 1122 close to the heating portion 1121 may be greater than the cross-sectional size away from the heating portion 1121. In this embodiment, the conductive portion 1122 may be conical. Or, the cross-sectional size of the end of the heating portion 1121 close to the conductive portion 1122 may be greater than the cross-sectional size of the conductive portion 1122.

In this embodiment, the heating structure 11 further includes a mounting member 113, and the mounting member 113 is assembled with the end of the tube body 111 provided with the tube opening 1111. The mounting member 113 is at least partially inserted in the tube body 111, and the two may be fixed by way of interference fit. It should be noted that the interference fit herein may be that the mounting member 113 and the tube body 111 are in direct contact with each other; or an adhesive is applied between the mounting member and the tube body; or the conductive portion 1122 is sandwiched between the mounting member and the tube body, so that the mounting member 113 is in interference fit with the tube body 111. Specifically, the mounting member 113 may be partially located in the tube body 111, and partially arranged out of the tube opening 1111. In some other embodiments, the mounting member 113 is not limited to be located in the tube body 111, and is arranged coaxially with the tube body 111, or may be located on the outer side of the tube opening 1111. The conductive portion 1122 may penetrate through the mounting member 113 and is connected to the heating portion 1121, so that the heating component 112 is fixed to the mounting member 113. By way of interference fit between the mounting member 113 and the tube wall of the tube body 111, it can be well ensured that the heating portion 1121 is centrally arranged in the tube body 111 and a certain degree of verticality is ensured. In this embodiment, the mounting member 113 is an insulating member, and the mounting member 113 may separate the two conductive portions 1122, so as to insulate the two conductive portions 1122. Of course, it can be understood that in some other embodiments, the mounting member 113 is not limited to the insulating member, the mounting member 113 may also be a metal member, and an insulating structure may be arranged on the surface where the mounting member is in contact with the conductive portion 1122. For example, an insulated sleeve capable of sleeving the conductive portion 1122 is embedded in the mounting member 113, or an insulated layer may be arranged on the surface where the mounting member is in contact with the conductive portion 1122. In some other embodiments, an insulated layer may also be arranged on the outer surface of the conductive portion 1122, so as to insulate the conductive portion and the mounting member 113, thereby insulating the two conductive portions 1122. In this embodiment, the mounting member 113 may play a role in fixing the heating component 112. In this embodiment, the mounting member 113 may be fixed in the tube body 111. Specifically, the mounting member 113 is located at a part of the tube wall in the tube body 111 and may be fixed to the inner wall of the tube body 111 by providing an adhesive, thereby preventing the mounting member 113 from moving. Of course, it can be understood that in some other embodiments, the mounting member 113 is not limited to be fixed by the adhesive. For example, the mounting member may also be supported by a base 13 on the holder 12.

In this embodiment, the mounting member 113 is cylindrical, and the cross-sectional shape of the mounting member may be equivalent to the cross-sectional shape of the cavity 1110 of the tube body 111. In addition, the cross-sectional area of the mounting member 113 is adapted to the cross-sectional area of the cavity 1110 of the tube body 111. In this embodiment, the width of the cross section of the mounting member 113 may differ from the width of the cross section of the tube body 111 by 0.01 mm-0.3 mm, so that the mounting member 113 is successfully inserted in the tube body 111, and a position limitation can be ensured. Specifically, the mounting member 113 is cylindrical, the axial direction of the mounting member is the same as the axial direction of the cavity 1110, and the diameter of the mounting member is adapted to the diameter of the cavity 1110. Specifically, the mounting member 113 may be slightly smaller than the diameter of the cavity 1110. It can be understood that in some other embodiments, the mounting member 113 is not limited to a cylindrical shape, and may also be of a square cylindrical shape or other shapes. In this embodiment, the mounting member 113 may be a ceramic body, a quartz tube, or any other insulating structure. In some embodiments, the mounting member 113 may be made of aluminum oxide or zirconium oxide.

In this embodiment, the mounting member 113 may include a first end 113a and a second end 113b. The first end 113a and the second end 113b are both located in the axial direction of the mounting member 113 and are arranged oppositely. The first end 113a may be located on the outer side of the tube body 111, that is, the first end 113a may pass through the tube opening 1111. It can be understood that in some other embodiments, the first end 113a may also be arranged close to the outer side of the tube body 111, that is, the first end 113a may be arranged at or arranged close to the tube opening 1111. Each conductive portion 1122 may penetrate through the second end 113b and the first end 113a, and the part of each conductive portion 1122 close to the first end 113a may be bent, and may pass through one side of the mounting member 113, thereby playing a role in limiting the mounting member 113.

In this embodiment, the mounting member 113 is provided with two channels 1131 extending from the second end 113b to the first end 113a, and each channel 1131 is arranged corresponding to one conductive portion 1122 and is configured for one conductive portion 1122 to penetrate through. In this embodiment, the two channels 1131 are independently arranged, and are not communicated with each other. The cross section of the channel 1131 may be approximately circular. In some other embodiments, the cross section of the channel 1131 is not limited to a circular shape, and may be of a square shape or a U shape. The mounting member 113 may be provided with two through holes or two through grooves penetrating through the second end 113b and the first end 113a, and each channel 1131 may be formed in each through hole or each through groove. It can be understood that in this embodiment, the mounting member 113 may also be provided with a through hole and a through groove, the through hole may form a channel 1131, and the through groove may form another channel 1131. In this embodiment, the cross-sectional area of the channel 1131 may be adapted to the cross-sectional area of the conductive portion 1122. Specifically, the cross-sectional area of the channel 1131 may be slightly greater than the cross-sectional area of the conductive portion 1122. In this embodiment, the cross-sectional area of the channel 1131 may be 0.03 mm²-0.28 mm². In this embodiment, the width of the cross section of the channel 1131 may be 0.2 mm-0.6 mm. Specifically, in this embodiment, the diameter of the channel 1131 may be 0.2 mm-0.6 mm.

In this embodiment, the heating component 112 is partially fixed to the end surface of the channel 1131 arranged towards the heating portion 1121. Specifically, a part of the heating component 112 may closely abut against the end surface of the channel 1131, namely the second end 113b. In some other embodiments, the heating component 112 is partially fixed to at least part of the inner wall of the channel 1131. For example, a part of the conductive portion 1122 is in interference fit with the channel 1131, so that the heating component is in close contact with the inner wall of the channel 1131 for fixing. Or, the heating component may be fixed to at least part of the inner wall of the channel 1131 by way of clamping through the conductive portion 1122, the connection portion 1123, or the heating portion 1121. For example, a clamping structure may be arranged on the conductive portion 1122, the connection portion 1123, and the inner wall of the channel 1131 for clamping.

Specifically, in this embodiment, the connection portion 1123 may be arranged at the second end 113b. Specifically, the connection portion 1123 may be fixed to the second end 113b. In this embodiment, the heating component 112 may include a first direction and a second direction. The first direction is perpendicular to the second direction. The second direction is a penetrating direction in which the conductive portion 1122 penetrates through the channel 1131, that is, may be used as the length direction of the heating component 112. The first direction may be the transverse direction of the heating component 112. Specifically, the first direction may be any direction on the cross section of the heating component 112, such as an X-axis direction or a Y-axis direction. If the cross section of the heating component 112 has a radial direction, the first direction may be the radial direction. The size of the end of the conductive portion 1122 close to the heating portion 1121 in the first direction may be equal to or greater than the size of the channel 1131 in the first direction, that is, the size of the connection portion 1123 in the first direction is greater than or equal to the size of the channel 1131 in the first direction. When the connection portion 1123 is circular, the size may be the diameter of the connection portion 1123, so that the cross-sectional area of the connection portion 1123 may be greater than or equal to the cross-sectional area of the channel 1131, that is, the connection portion 1123 cannot penetrate into the channel 1131 and thus can be fixed to the second end 113b. In some other embodiments, the connection portion 1123 is not limited to a circular shape, and the size is not limited to the diameter of the connection portion 1123, and may be the length or width of the cross section of the connection portion 1123. In some other embodiments, the connection portion 1123 may also be fixed to the second end 113b by way of pasting, and is not limited to be fixed by increasing the size of the connection portion in the first direction. Fixing the connection portion 1123 to the second end of the mounting member 113 may play a role in fixing the heating component 112 in the tube body 111, so as to limit the heating component 112 from moving to the side of the tube opening 1111, and enable the heating component 112 to be centrally fixed in the tube body 111 and form a uniform gap with the tube wall of the tube body 111, so that the temperature of the tube body 111 is uniform and the mounting of the heating component 112 is facilitated, the mounting efficiency of the heating component 112 can be improved, and the mounting stability and reliability of the heating component 112 can be improved. It can be understood that in some other embodiments, when the connection portion 1123 is omitted, the size of the end of the conductive portion 1122 close to the heating portion 1121 in the first direction may be equal to or greater than the size of the channel 1131 in the first direction, that is, the end of the conductive portion 1122 close to the heating portion 1121 may abut against the second end 113b, so that the heating portion 1121 is fixed to the second end 113b. In some other embodiments, the size of the end of the heating portion 1121 close to the conductive portion 1122 in the first direction may also be configured to be greater than the size of the channel 1131 in the first direction, so that the end of the heating portion 1121 abuts against the end surface of the second end 113b.

Specifically, when the heating component 112 is assembled with the tube body 111, the heating component 112 may be assembled with the mounting member 113, so that the connection portion 1123 is located at the second end of the mounting member 113, and then, the connection portion is mounted into the tube body 111 together with the mounting member 113. The end of the heating portion 1121 away from the conductive portion 1122 may be in interference fit with a part of the inner wall of the pointed top 111b, that is, may support the pointed top 111b to limit the heating component 112 from moving to the tip of the pointed top 111b. That is, at least two positions of the heating component 112 on the axis may be fixed, so as to keep the heating component 112 centrally arranged in the tube body 111 and form a uniform gap with the tube wall of the cylindrical body 111a.

In this embodiment, the outer wall of the tube body 111 is provided with a positioning portion 114, and the positioning portion 114 may be configured for overall mounting and positioning of the heating structure 11. Specifically, the heating structure 11 may be positioned and mounted on the holder 12 to limit the movement of the heating structure 11. In this embodiment, the positioning portion 114 is arranged close to the tube opening 1111. In this embodiment, the positioning portion 114 may be of a ring structure, for example, may be a fixed flange. In this embodiment, the positioning portion 114 may be fixed to the outer wall of the tube body 111 through a connection structure. Specifically, the connection structure may be a pasting structure, such as an adhesive. It can be understood that in some other embodiments, the positioning portion 114 and the tube body 111 may be integrally formed. Specifically, the positioning portion 114 and the tube body 111 may be integrally formed by way of injection molding.

In this embodiment, the holder 12 may include a holder body 121, and the holder body 121 may be partially embedded in the casing 30 and is in interference fit with the casing 30. The holder body 121 is provided with an accommodating cavity 1210, and the accommodating cavity 1210 may be configured to accommodate the extractor 40 for accommodating the aerosol-generating substrate 200. The accommodating cavity 1210 may be of an open structure having an approximately L-shaped opening, and the opening may extend from the top surface of the holder body 121 to the side wall of the holder body 121. A support wall 122 is arranged in the holder 12, and the support wall 122 may be configured to support the extractor 40. In this embodiment, the holder 12 is provided with a mounting hole 123, and the mounting hole 123 may be located on the support wall 122 and is configured for a part of the heating structure 11 to penetrate through. In this embodiment, the mounting hole 123 may be provided for a part of the tube body 111. Specifically, a part of the tube body 111 located on the side of the positioning portion 114 away from the tube opening 1111 may pass through the mounting hole 123.

In this embodiment, the heating assembly 10 further includes a base 13. The base 13 is arranged at the bottom of the holder body 121. The base 13 includes a bottom wall 131 and a limiting structure 132 arranged on the bottom wall 131. The bottom wall 131 is located at one end of the holder 12 and may support the mounting member 113 passing through the tube opening 1111, so that the mounting member 113 is fixed in the tube body 111. The limiting structure 132 is located in the holder 12. Specifically, the limiting structure 132 is located on the side of the support wall 122 away from the accommodating cavity 1210. The limiting structure 132 may cooperate with the positioning portion 114 for limiting, so as to limit the movement and rotation of the positioning portion 114, thereby limiting the movement and rotation of the heating structure 11. Specifically, in this embodiment, the limiting structure 132 may wrap the outer circumference of the positioning portion 114, so as to limit the rotation of the positioning portion 114. In this embodiment, the inner wall of the limiting structure 132 is provided with a limiting boss 1321, and the limiting boss 1321 may support the positioning portion 114, so as to limit the movement of the positioning portion 114. In this embodiment, the base 13 may be detachably connected to the holder 12. When the heating assembly 10 is assembled, the heating structure 11 may be first mounted on the base 13, and then, a part of the tube body 111 of the heating structure 11 is penetrated into the accommodating cavity 1210 from the mounting hole 123, so that the heating structure 11 and the base 13 are assembled to the holder 12 together. The base 13 is arranged detachably to facilitate the replacement of the heating structure 11.

In this embodiment, the heating assembly 10 further includes a seal structure 14, and the seal structure 14 is arranged between the outer wall of the heating structure 11 and the inner wall of the mounting hole 123. Specifically, the seal structure 14 may sleeve the outer circumference of the tube body 111 and is located on the side of the positioning portion 114 away from the tube opening 1111, and may be embedded in the mounting hole 123 to seal a gap between the heating structure 11 and the mounting hole 123, so as to buffer vibration and prevent the aerosol from overflowing from the mounting hole 123. In this embodiment, the seal structure 14 may be a seal ring, for example, a rubber ring or a silicone ring.

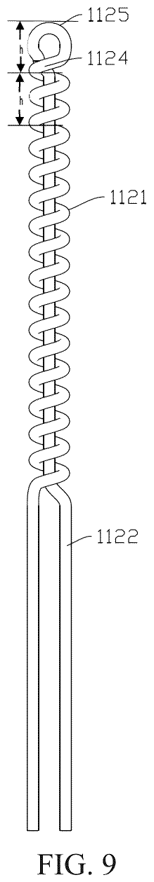

FIG. 9 shows a second embodiment of an aerosol-generating device of the present disclosure. The second embodiment differs from the first embodiment in that: the end of the heating portion 1121 close to the pointed top 111b has the maximum radial size or width of the heating portion 1121. Specifically, the heating portion 1121 includes a spiral section 1124 arranged close to the pointed top 111b. The end of the spiral section close to the pointed top 111b includes an annular portion 1125. The annular portion 1125 has the maximum radial size of the heating portion 1121, that is, the diameter of the annular portion 1125 is greater than the diameter of the cross section of the heating portion 1121 at another position. In this case, the end of the heating portion 1121 close to the pointed top 111b may play roles in mounting and limiting, and may ensure that a middle part of the heating portion 1121 is not in direct contact with the inner wall of the tube body 111. In addition, the heat dissipation area may be increased, and the resistance may be reduced, thereby avoiding that the temperature of the end of the heating portion 1121 close to the pointed top 111b is excessively high. It can be understood that the radial size of the annular portion 1125 may also be equal to the radial size of the spiral section, as long as it is ensured that the spiral section and the tube wall are spaced apart, and the interval is controlled to be 0.05 mm-0.5 mm.

As shown in FIG. 9, the end of the spiral section 1124 close to the pointed top 111b includes a top. The top has a set height h in the axial direction. The resistance value of the spiral section adjacent to the top and having the same height h is greater than the resistance value of the top. That is, the resistance value of the top of the heating portion 1121 that cooperates with the pointed top 111b is relatively low, and the heat generated by the top of the heating portion 1121 in a powered-on state is relatively low relative to the heat generated by another part, thereby avoiding an excessively high temperature at the top of the heating structure 11, avoiding over-roasting of the aerosol-generating substrate 200, and improving the taste of the aerosol. In some embodiments, the spiral section may include a spiral portion and a straight portion inside the spiral portion, or may include only the spiral portion.

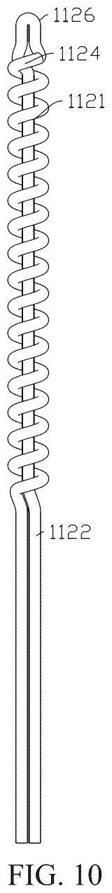

FIG. 10 shows a third embodiment of an aerosol-generating device of the present disclosure. The third embodiment differs from the second embodiment in that the heating portion 1121 includes a spiral section 1124 close to the pointed top 111b, and the radial size or width size of the end of the spiral section 1124 close to the pointed top 111b is less than the maximum radial size of the spiral section 1124. In this embodiment, the spiral section 1124 includes a bent portion 1126 close to the pointed top 111b, and the width of the bent portion is less than the maximum radial size of the spiral section. That is, the width size of the top of the heating portion 1121 is relatively small. On one hand, the width size of the top of the heating portion may be adapted to the pointed top 111b of the tube body 111 for limiting. On the other hand, the contact area with the pointed top 111b may be reduced, and heat generation and light wave radiation may also be reduced. That is, the temperature of the end close to the pointed top 111b is less than the temperature of a part away from the pointed top 111b, so as to avoid an excessively high temperature at the top of the heating structure 11. In addition, the width size of the top of the heating portion 1121 is reduced, and the heat capacity of the heating portion 1121 may also be reduced.

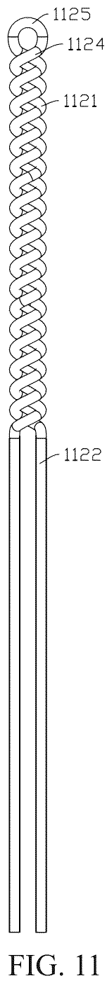

FIG. 11 shows a fourth embodiment of an aerosol-generating device of the present disclosure. The fourth embodiment differs from the second embodiment in that the spacing between the annular portion 1125 and an adjacent spiral section is greater than the spacing between the spiral sections, and the spiral section away from the annular portion 1125 is spaced apart from the inner wall of the tube body 111, so as to reduce the light wave radiation generated when the heating portion 1121 is powered on, thereby avoiding an excessively high temperature at the top of the heating structure 11, avoiding over-roasting of the aerosol-generating substrate 200, and improving the taste of the aerosol.

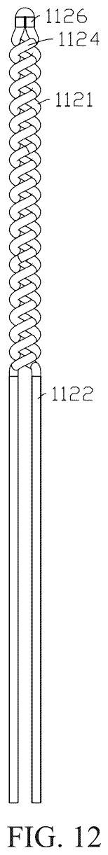

FIG. 12 shows a fifth embodiment of an aerosol-generating device of the present disclosure. The fifth embodiment differs from the third embodiment in that the spacing between the bent portion 1126 and an adjacent spiral section is greater than the spacing between the spiral sections, and the spiral section away from the bent portion 1126 is spaced apart from the inner wall of the tube body 111, so as to reduce the light wave radiation generated when the top of the heating portion 1121 is powered on, thereby avoiding an excessively high temperature at the top of the heating structure 11, avoiding over-roasting of the aerosol-generating substrate 200, and improving the taste of the aerosol.

In some other embodiments, the end of the spiral section close to the pointed top 111b is not limited to include a bent portion 1126 or an annular portion 1125. The end of the spiral section 1124 close to the pointed top 111b may include only a tip or a flat portion. The width of the tip or the flat portion may be less than the outer diameter of the spiral section 1124. The tip and the flat portion abut against the top end of the pointed top 111b. The spiral section 1124 of the heating portion 1121 away from the tip or the flat portion may be spaced apart from the inner wall of the tube body 111. That is, the heating portion 1121 may cooperate with the pointed top 111b through the tip or the flat portion for limiting. Moreover, the light wave radiation generated during powering on may be reduced by arranging the tip or the flat portion, thereby avoiding an excessively high temperature at the top of the heating structure 11, avoiding over-roasting of the aerosol-generating substrate 200, and improving the taste of the aerosol.

In some other embodiments, a limiting portion is arranged between the heating portion 1121 and the mounting member 113 and is configured to limit the distance between the heating portion 1121 and the mounting member 113. Specifically, the limiting portion may be an insulated sleeve sleeving the end of a heating wire or the conductive portion 1122. For example, the insulated sleeve may be made of aluminum oxide, zirconium oxide, or the like. The limiting portion may also be a bold portion of the end of the heating wire or a bold portion of the conductive portion 1122. The limiting portion is limited on the top surface of the mounting member 113 to limit the position of the conductive portion 1122 after passing through the mounting member 113, thereby facilitating batch production and ensuring the consistency of the heating structure, and finally facilitating temperature control and draw sensation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure, comprising:
a heating component;
a tube body; and
a mounting member,
wherein the tube body is provided with a tube opening,
wherein the mounting member is assembled with an end of the tube body provided with the tube opening,
wherein the heating component comprises a heating portion and a conductive portion,
wherein the heating portion is arranged in the tube body and is at least partially spaced apart from a tube wall of the tube body so as to radiate infrared light through the tube body to heat an aerosol-generating substrate, and
wherein the conductive portion penetrates through the mounting member and is connected to the heating portion so as to fix the heating component to the mounting member.

2. The heating structure of claim 1, wherein the mounting member is provided with a channel for the conductive portion to penetrate through, and
wherein the heating component is at least partially fixed to an end surface of the channel arranged toward the heating portion and/or is at least partially fixed to an inner wall of the channel.

3. The heating structure of claim 2, wherein the heating component has a first direction and a second direction perpendicular to the first direction, the second direction being a penetrating direction in which the conductive portion penetrates through the channel, and
wherein a size of an end of the conductive portion close to the heating portion in the first direction is greater than or equal to a size of the channel in the first direction, or a size of an end of the heating portion close to the conductive portion in the first direction is greater than or equal to a size of the channel in the first direction.

4. The heating structure of claim 1, wherein the mounting member is provided with a channel for the conductive portion to penetrate through, and has a first end located at or close to the tube opening and a second end arranged opposite the first end,
wherein each channel extends from the second end to the first end,
wherein an end of the conductive portion close to the heating portion is provided with a connection portion connected to the heating portion, and
wherein the connection portion is fixed to the second end.

5. The heating structure of claim 4, wherein a cross-sectional area of the connection portion is greater than or equal to a cross-sectional area of the channel.

6. The heating structure of claim 5, wherein the cross-sectional area of the connection portion ranges from 0.07 mm² to 0.8 mm², and
wherein the cross-sectional area of the channel ranges from 0.03 mm² to 0.28 mm².

7. The heating structure of claim 5, wherein a width of the cross section of the connection portion ranges from 0.2 mm to 1.5 mm, and
wherein a width of the cross section of the channel ranges from 0.2 mm to0.6 mm.

8. The heating structure of claim 2, wherein the mounting member is provided with a through hole or a through groove, and
wherein the channel is formed in the through hole or the through groove.

9. The heating structure of claim 1, wherein two conductive portions are provided, and
wherein the two conductive portions are insulated or spaced apart.

10. The heating structure of claim 9, wherein the mounting member comprises an insulating member, or a surface where the mounting member is in contact with the conductive portion is provided with an insulating structure, and
wherein the two conductive portions are insulated through the mounting member.

11. The heating structure of claim 1, wherein the mounting member is at least partially inserted in the opening of the tube body, and
wherein the mounting member is in interference fit with the tube body.

12. The heating structure of claim 1, wherein the tube body comprises a pointed top, and
wherein an end of the heating portion away from the conductive portion is in interference fit or in contact with a part of an inner wall of the pointed top.

13. The heating structure of claim 12, wherein an end of the heating portion close to the pointed top has a maximum radial size or width size of the heating portion.

14. The heating structure of claim 12, wherein the heating portion comprises a spiral section, and
wherein a radial size or width size of an end of the heating portion close to the pointed top is less than or equal to a maximum radial size of the spiral section.

15. The heating structure of claim 12, wherein the heating portion comprises a spiral section close to the pointed top,
wherein an end of the spiral section close to the pointed top comprises a bent portion or an annular portion,
wherein a spacing between the bent portion or the annular portion and an adjacent spiral section is greater than a pitch of the spiral section, and
wherein a spiral section away from the bent portion or the annular portion is spaced apart from an inner wall of the tube body.

16. The heating structure of claim 12, wherein the heating portion comprises a spiral section close to the pointed top,
wherein an end of the spiral section close to the pointed top comprises a tip or a flat portion,
wherein a width of the tip or a flat portion is less than an outer diameter of the spiral section,
wherein the tip or the flat portion abuts against an inner wall of the pointed top, and
wherein a spiral section away from the tip or the flat portion is spaced apart from an inner wall of the tube body.

17. The heating structure of claim 12, wherein the heating portion comprises a spiral section close to the pointed top,
wherein an end of the spiral section close to the pointed top comprises a top,
wherein an axial direction of the top has a set height, and
wherein a resistance value of the spiral section adjacent to the top and having a same height is greater than a resistance value of the top.

18. The heating structure of claim 4, wherein a part of the conductive portion arranged close to the first end is bent and passes through one side of the mounting member.

19. The heating structure of claim 1, wherein an outer wall of the tube body is provided with a positioning portion configured for mounting and positioning a heating structure.

20. The heating structure of claim 1, wherein a limiting portion is arranged between the heating portion and the mounting member and is configured to limit a distance between the heating portion and the mounting member.

21. A heating assembly, comprising:
a holder; and
the heating structure of claim 1 arranged on the holder.

22. The heating assembly of claim 21, wherein the holder is provided with a mounting hole for a part of the heating structure to penetrate through, and
wherein a seal structure is arranged between an outer wall of the heating structure and an inner wall of the mounting hole.

23. The heating assembly of claim 21, wherein a limiting structure configured for limiting and mounting the heating structure is arranged in the holder.

24. An aerosol-generating device, comprising:
the heating structure of claim 1; and
a power supply assembly conductively connected to the heating structure.
